(19) United States
(12) Patent Application Publication
(10) Pub. No.: US 2023/0331145 A1
(43) Pub. Date: Oct. 19, 2023

(54) SAFETY LIGHTING SYSTEM

(71) Applicant: Ptahchi Rael Tameen, Atlanta, GA (US)

(72) Inventor: Ptahchi Rael Tameen, Atlanta, GA (US)

(21) Appl. No.: 18/127,069

(22) Filed: Mar. 28, 2023

Related U.S. Application Data
(60) Provisional application No. 63/372,951, filed on Apr. 19, 2022.
(60) Provisional application No. 63/417,450, filed on Oct. 19, 2022.

(51) Int. Cl. B60Q 1/44; B60Q 1/26; B60Q 1/50

(52) U.S. Cl. CPC B60Q 1/444; B60Q 1/2676; B60Q 1/535; B60Q 1/2665

(57) ABSTRACT

A safety lighting system for vehicles. A safety lighting system may include a display cover including a first portion, a second portion, and a third portion. The safety lighting system may further include at least one light source configured to selectively illuminate the first, second, and third portions of the display cover. The safety lighting system may further include a controller configured receive at least one of acceleration/deceleration information, braking information or throttle control information relating to the vehicle, and to responsively cause illumination of the first portion upon at least one of acceleration or operation of the throttle of the vehicle, to cause illumination of the second portion upon at least one of relatively low deceleration of the vehicle or deceleration of the vehicle without braking, and to cause illumination of the third portion upon at least one of relatively high deceleration or braking of the vehicle.

### CROSS-REFERENCE TO RELATED APPLICATIONS

This application claims the benefit of U.S. Provisional Application Ser. No. 63/372,951 filed Apr. 19, 2022, and this Application claims the benefit of U.S. Provisional Application Ser. No. 63/417,450 filed Oct. 19, 2022, each of which are incorporated herein in their entirety.

### TECHNICAL FIELD

The present invention relates generally to a safety lighting system. More specifically, the present invention relates to a safety lighting system for all vehicles and for helmets and safety gear for motorcycles, cyclists, and the like.

### BACKGROUND

Since the first motor vehicle was created, the rear tail lighting system was only designed to alert other vehicles, motorcycles, cyclists, that the brakes were being used. According to the Bureau of Transportation Statistics, approximately thirteen car accidents occur somewhere in the US every sixty seconds. This means there are around seven million accidents each year across the country. As we know, accidents occur within a fraction of a second, mostly due to the driver behind another motor vehicle not being forewarned of a sudden stop of the front vehicle, which results in most rear-ended collisions. There is no forewarning of the braking condition (e.g., slowing down using the brakes or not), catching the motorists, cyclists or motorcyclists off guard and gives only seconds to react. Without the ability to know beforehand of a sudden stop, the motorist, cyclists, or motorcyclist have no way to assess the braking conditions and rather than making analytical decisions, the motorist, cyclist or motorcyclist reacts emotionally which results in an accident.

Since the one-dimensional brake lighting system does not provide any visual indication other than the brakes have been activated, misinterpretations of the precise braking conditions are common and dangerous.

### SUMMARY

Described herein is a safety lighting system that can be used for all vehicles, and in particular, all motor vehicles. Additionally, described herein is a safety lighting system that can be implemented on helmets, such as helmets for operators and/or passengers on motorcycles, bicycles, and the like. As used herein, the term “vehicles” may refer to any machine that transports people or cargo, and may include wagons, bicycles, motor vehicles (e.g., motorcycles, cars, trucks, buses, mobility scooters/vehicles for disabled people, etc.), railed vehicles (e.g., trains, trams, etc.), watercraft vehicles (e.g., ships, boats, underwater vehicles), amphibious vehicles (e.g., screw propelled vehicles, hovercraft), aircrafts (e.g., airplanes, helicopters, aerostats, flying cars, flying bikes/bicycles, flying suits, and spacecraft), and the like.

In particular, embodiments of the present invention provide a safety lighting system adapted for attachment to or integration with all electric or gas vehicles (e.g., car, truck, tractors, construction vehicles/equipment, motorcycle, bicycle), motorcyclist and cyclists' helmets or other safety gear to increase the safety for the driver of the vehicle and surrounding motorists, riders or pedestrians. In particular, the rear tail lighting system for motor vehicles, provides an arrangement of lights (e.g., light emitting diodes) that are programmed for illumination in a predetermined sequence in response to the activation and deactivation of the vehicle brakes and more specifically in one case, proportional to a rate of deceleration of the associated vehicle as well as the deceleration of the speedometer.

In some embodiments of the invention, a safety lighting system is presented. The safety lighting system includes a display cover including a first portion, a second portion, and a third portion, at least one light source configured to selectively illuminate the first, second, and third portions of the display cover, and a controller communicatively coupled to the vehicle and configured to receive at least one of acceleration/deceleration information, braking information, or throttle control information relating to the vehicle. The controller is further configured to responsively cause illumination of the first portion upon at least one of acceleration or operation of the throttle of the vehicle, to cause illumination of the second portion upon at least one of relatively low deceleration of the vehicle or deceleration of the vehicle without braking, and to cause illumination of the third portion upon at least one of relatively high deceleration or braking of the vehicle.

In some embodiments of the invention, a method using a safety lighting system is presented. The safety lighting system includes a display cover including a first portion, a second portion, and a third portion, at least one light source configured to selectively illuminate the first, second, and third portions of the display cover, and a controller. The method includes receiving, at the controller, first acceleration/deceleration information and first braking information of the vehicle. The method further includes determining, by the controller and based on the first acceleration/deceleration information, that the vehicle is accelerating, and in response, illuminating a first portion. The method further includes receiving, at the controller, second acceleration/deceleration information and second braking information of the vehicle. The method further includes determining, by the controller and based on the second acceleration/deceleration information and the second braking information, that the vehicle is decelerating without a braking action, and in response, illuminating a second portion. The method further includes receiving, at the controller, third acceleration/deceleration information and third braking information of the vehicle. The method further includes determining, by the controller and based on the third acceleration/deceleration information and the third braking information, that the vehicle is decelerating with a braking action, and in response, illuminating a third portion.

In some embodiments of the invention, a vehicle includes the safety lighting system described herein.

These and other embodiments can each optionally include one or more of the following features.

In some embodiments of the invention, the display cover includes or is positioned over a taillight of the vehicle. In some embodiments of the invention, each portion of the safety lighting system is configured to be visible to a driver of another vehicle that is located behind the vehicle.

In some embodiments of the invention, the display cover is positioned on an outside surface of at least one of a driver side mirror or a passenger side mirror of the vehicle.

In some embodiments of the invention, the at least one light source includes a first light element configured to selectively illuminate the first portion, a second light element configured to selectively illuminate the second portion, and a third light element configured to selectively illuminate the third portion. In some embodiments of the invention, an outer surface of each light element is transparent or translucent.

In some embodiments of the invention, when illuminated, the first light element, the second light element, and the third light element are visible through the outer surface of each lighting element. In some embodiments of the invention, an inner surface of each light element is an adhesive surface. In some embodiments of the invention, when illuminated, the first light element, the second light element, and the third light element are visible through a transparent or translucent outer surface of the housing. In some embodiments of the invention, the safety lighting system includes

In some embodiments of the invention, the first light element, the second light element, and the third light element each include at least one of a light emitting diode (LED), a plurality of LEDs, an incandescent light, halogen light, a metal halide light.

In some embodiments of the invention, the first portion, the second portion, and the third portion are installed on or within a rear facing surface of a helmet.

In some embodiments of the invention, the at least one light source is wirelessly connected to the controller.

In some embodiments of the invention, the safety lighting system includes a housing, wherein the housing incorporates or encloses at least one of the first portion, the second portion, the third portion, the at least one light source, and the controller.

In some embodiments of the invention, the controller is operatively connected to a vehicle power source. In some embodiments of the invention, the controller is operatively connected to a power source that is separate from a vehicle power source.

In some embodiments of the invention, the safety lighting system includes one or more solar panels that are configured to be mounted on top of the vehicle or on top of a helmet, wherein system includes a power source operatively coupled to the controller and configured to be charged by the one or more solar panels.

In some embodiments of the invention, the controller is configured to illuminate each portion based on a dynamic display configuration, wherein the dynamic display configuration is based on at least one of an illumination pattern, an illumination area, an illumination frequency, an illumination color, and an illumination intensity.

In some embodiments of the invention, the first portion is configured for illumination in a first color, the second portion is configured for illumination in a second color different from the first color, and the third portion is configured for illumination in a third color different from the first and second colors. In some embodiments of the invention, the first portion is configured for illumination in a red color, the second portion is configured for illumination in a yellow or amber color, and the third portion is configured for illumination in a green color.

In some embodiments of the invention, a safety lighting system is presented. The safety lighting system includes a first light source, a second light source, a third light source, and a display cover that encloses the first light source, the second light source, and the third light source. The safety lighting system includes a controller communicatively coupled to the vehicle and configured to receive at least one of acceleration/deceleration information, braking information, or throttle control information relating to the vehicle. The controller is configured to responsively cause illumination to the first light source upon receiving information associated with at least one of acceleration or operation of the throttle of the vehicle, responsively cause illumination to the second light source upon receiving information associated with at least one of relatively low deceleration of the vehicle or deceleration of the vehicle without braking, and responsively cause illumination second light source upon receiving information associated with at least one of relatively high deceleration or braking of the vehicle.

In some embodiments of the invention, a vehicle includes the safety lighting system described herein.

These and other embodiments can each optionally include one or more of the following features.

In some embodiments of the invention, the display cover includes or is positioned over a taillight of the vehicle. In some embodiments of the invention, illumination to the first light source, the second light source, or the third light source is configured to be visible to a driver of another vehicle that is located behind the vehicle. In some embodiments of the invention, the display cover is positioned on an outside surface of at least one of a driver side mirror or a passenger side mirror of the vehicle.

In some embodiments of the invention, the first light source includes a first light element configured to selectively illuminate a first portion of the display cover, the second light source includes a second light element configured to selectively illuminate a second portion of the display cover, and the third light source includes a third light element configured to selectively illuminate a third portion of the display cover.

In some embodiments of the invention, an outer surface of each light element is transparent or translucent. In some embodiments of the invention, an inner surface of each light element is an adhesive surface. In some embodiments of the invention, when illuminated, the first light element, the second light element, and the third light element are visible through a transparent or translucent outer surface of the display cover.

In some embodiments of the invention, the first light element, the second light element, and the third light element each include at least one of a light emitting diode (LED), a plurality of LEDs, an incandescent light, a halogen light, a metal halide light.

In some embodiments of the invention, the first light source, the second light source, or the third light source are installed on or within a rear facing surface of a helmet.

In some embodiments of the invention, the first light source, the second light source, or the third light source are wirelessly connected to the controller.

In some embodiments of the invention, the safety lighting system further includes a housing, wherein the housing incorporates or encloses the first light source, the second light source, the third light source, and the controller.

In some embodiments of the invention, the controller is operatively connected to a vehicle power source. In some embodiments of the invention, the controller is operatively connected to a power source that is separate from a vehicle power source.

In some embodiments of the invention, the safety lighting system includes one or more solar panels that are configured to be mounted on top of the vehicle or on top of a helmet, wherein the safety lighting system includes a power source operatively coupled to the controller and configured to be charged by the one or more solar panels.

In some embodiments of the invention, the controller is configured to illuminate each light source based on a dynamic display configuration, wherein the dynamic display configuration is based on at least one of an illumination pattern, an illumination area, an illumination frequency, an illumination color, and an illumination intensity.

In some embodiments of the invention, the first light source is configured for illumination in a first color, the second light source is configured for illumination in a second color different from the first color, and the third light source is configured for illumination in a third color different from the first and second colors.

In some embodiments of the invention, the first light source is configured for illumination in a red color, the second light source is configured for illumination in a yellow or amber color, and the third light source is configured for illumination in a green color.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The accompanying drawings, which are incorporated in and constitute a part of this specification, illustrate various embodiments of the present invention and, together with the general description of the invention given above, and the detailed description of the embodiments given below, serve to explain the embodiments of the invention. In the drawings, like reference numerals are used to indicate like parts in the various views.

FIGS. 1A, 1B illustrate a view of a safety lighting system for a vehicle.

FIGS. 2A-2C illustrate views of using the safety lighting system for the vehicle of FIG. 1.

FIGS. 3A, 3B illustrate a view of a safety lighting system for a vehicle and for a helmet.

FIG. 4 illustrates a perspective view of the safety lighting system and the vehicle of FIG. 3A.

FIGS. 5A-5C illustrate views of using the safety lighting system for the helmet of FIG. 3A.

FIGS. 6A-6E illustrate views of using the safety lighting system for a helmet.

FIG. 7 illustrates an example block diagram of the inputs and outputs of a controller of an example safety lighting device.

### DETAILED DESCRIPTION

This document describes a safety lighting system for motor vehicles and for helmets for motorcycles and cyclists. In particular, embodiments of the present invention provide a safety lighting system adapted for attachment to, or integration with, all electric or gas motor vehicles, (e.g., car, truck, tractors, construction vehicles/equipment, motorcycle, bicycle), as well as helmets worn by motorcyclists and cyclists, to increase the safety for the driver of the vehicle and surrounding motorists, riders, and/or pedestrians. In particular, the safety lighting system described herein is for all motor vehicles, and provides an arrangement of lights (e.g., light emitting diodes) that are configured to be illuminated in a predetermined sequence in response to the activation and deactivation of the vehicle brakes and more specifically, proportional to a rate of deceleration or acceleration of the associated vehicle.

The safety lighting system provides the ability to display various distinct patterns, and provides for arrangements of lights that enable surrounding motorists, motorcyclists, cyclists, riders and pedestrians a quick and effective indication of the slowing, braking, and/or stopping (or stopped) conditions of the vehicle to which the safety lighting system is equipped. The safety lighting system provides many advantages over conventional braking rear lights. The safety lighting system may provide significantly more information to motorists, motorcyclists, riders, and cyclists such as indications of the precise braking conditions which is not possible with conventional, one-dimensional braking systems. As a result, both the vehicle's user and surrounding or adjacent drivers and/or pedestrians benefit from increased safety due to the ability for the other drivers and/or pedestrians to quickly and accurately interpret the visual indication of the braking conditions and appropriately activate their own brakes or take other action, as necessary. In sum, through use of the safety lighting system, other motorists, motorcyclists, cyclists, riders or pedestrians will be afforded additional information to assess and react to the vehicle so as to take any necessary corrective action.

In an exemplary embodiment, the safety lighting system described herein may include a display cover that includes three portions: a first green portion (e.g., illuminated during acceleration, i.e., stepping on the gas pedal, or accelerating greater than a particular rate), a second yellow or amber portion (e.g., illuminated during decelerating at a particular rate without braking), and a third red portion (e.g., illuminated during stopping, braking and/or decelerating at a particular rate). The system may be configured to illuminate the third (red) portion of the display cover when the brakes are activated causing the red portion of the rear lighting system to illuminate a solid red color that stays illuminated as long as the braking system is activated. The system may be configured to illuminate the second (yellow/amber) portion of the display cover in response to and proportional to the rate of deceleration of the associated vehicle whether by releasing pressure off the gas pedal or deactivation of the braking system which also shows as deceleration on the speedometer which can cause illumination of the second portion as well.

In some implementations, the system may be configured to illuminate the first (green) portion of the display cover for sequential illumination in response to and proportional to the rate of acceleration of the associated vehicle, where the vehicle is accelerated, such as when pressure is applied to the gas pedal. The illumination of the first (green) portion may continue as long as pressure is applied to the gas pedal or other acceleration mechanism. Once pressure is released from the gas pedal or acceleration mechanism, deceleration occurs of the associated vehicle, which can be detected by monitoring the speedometer, which may cause activation/illumination the second (yellow/amber) portion of the display cover. Once pressure is applied to the brakes or braking is otherwise applied (e.g., autonomous vehicles), the second (yellow/amber) portion may no longer be illuminated and the third (red) portion of the display cover may be illuminated (e.g., red LEDs or a light source that illuminates a red material can be activated, or clear light can be passed through a translucent red material) and once the brakes are released or braking is ceased, illumination of the third (red) portion can cease and in turn the second (yellow/amber) portion is illuminated. Accordingly, once pressure is applied to the gas pedal or the throttle is activated/opened, then acceleration increases which causes illumination of the first (green) portion throughout the continual pressure (e.g., during acceleration or maintaining a constant speed). This illustrates the sequential illumination of the three portions of the display cover, specifically the first (green) portion, the second (yellow/amber) portion, and the third (red) portion. Alternatively, in some implementations, a single light source is used to illuminate the three different portions of a display cover.

In some implementations, the rate of deceleration or acceleration of a vehicle which causes activation of the first, second and/or third portions of the display cover are not necessarily set by absolute values. Rather, the determined rate of deceleration may be determined by a controller of the safety lighting system as a ratio or percentage value indicative of an amount of deceleration or acceleration relative to the vehicles acceleration or deceleration at some time immediately before the deceleration or acceleration of interest. For example, as soon as a vehicle decelerates (e.g., less than 100% of a current speed), the yellow portion of the safety lighting system is activated and illuminated. As soon as a vehicle accelerates (e.g., 1% or more of a current speed), the green portion of the safety lighting system is activated and illuminated. As soon as a vehicles' brakes are engaged (e.g., 1% or more of pressure applied to a breaking pedal that may trigger the normal brake light system of the vehicle), the red portion of the safety lighting system is activated and illuminated. In some implementations, both the deceleration and acceleration of the speedometer may be synchronized directly to the safety lighting system. For example, when the speedometer decelerates, the yellow portion of the safety lighting system may be activated and when the speedometer accelerates, the green portion of the safety lighting system may be activated and illuminated.

In some implementations, the first, second and/or third portions of the display cover can be dynamically illuminated to provide varying illumination patterns (e.g., constant or continuous flashing), illumination areas (e.g., larger or smaller areas, sub-areas, and/or combinations of areas), illumination frequency (e.g., flashing rate of each light), illumination color (e.g., for color changing lights), and illumination intensity (e.g., controlling a brightness of illumination for each portion of the display cover by controlling the power to each light source or by any other means).

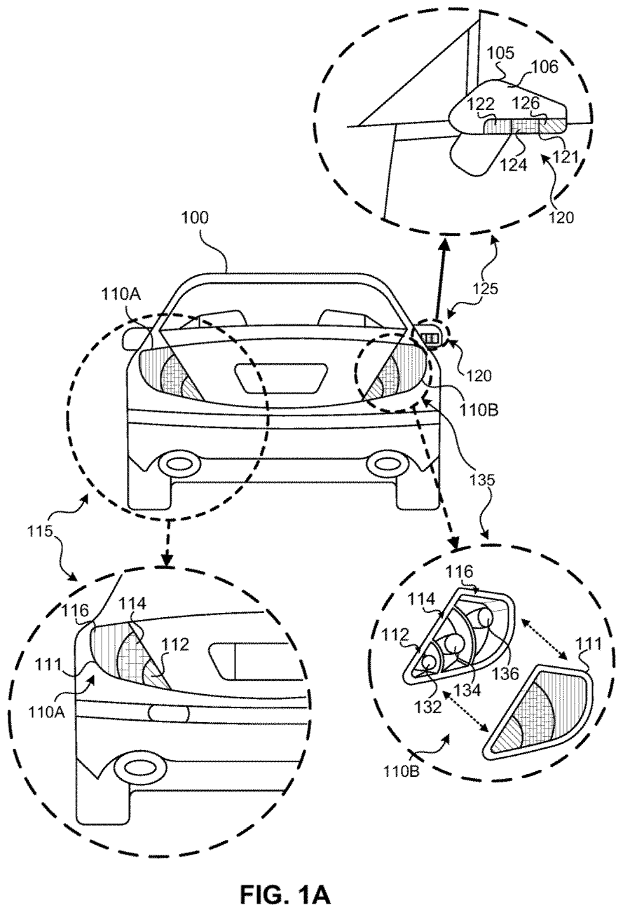

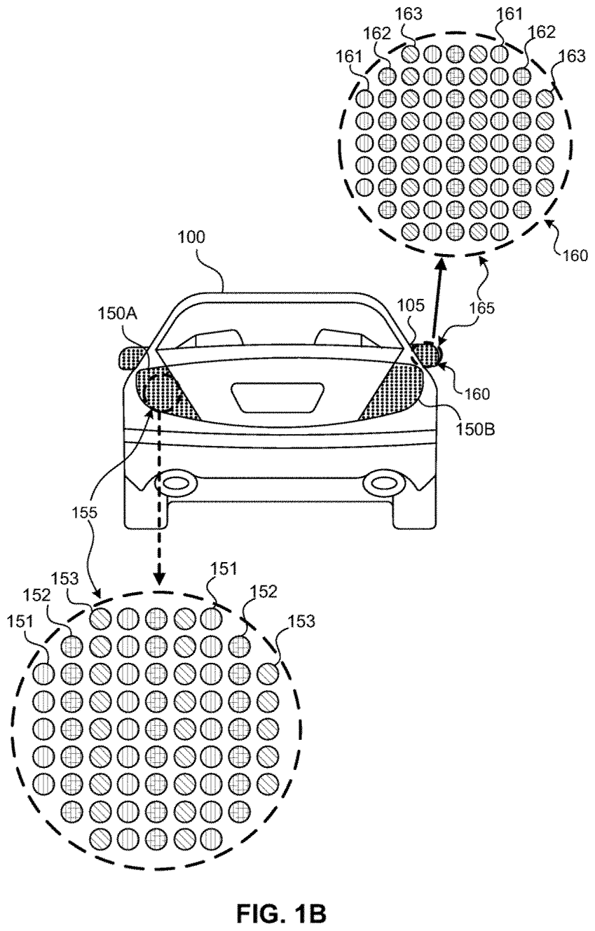

FIG. 1A illustrates a view of a safety lighting system 110 for use in conjunction with, and/or mounted on, a vehicle 100 in accordance with aspects of the present invention. In particular, FIG. 1A illustrates a safety lighting system 110A, B (also referred to herein as safety lighting system 110) mounted on the rear of the vehicle 100 (e.g., positioned on and/or constituting a right and left taillight area), and a second safety lighting system 120 located on one of the side view mirrors of the vehicle 100 (e.g., a passenger side view mirror in the illustrated embodiment, or could be located on both a driver side view mirror and a passenger side view mirror). As illustrated in the expanded area 115 for the driver side of the vehicle 100, the safety lighting system 110 may include a display cover 111 (e.g., a housing or cover) that includes three different portions (e.g., first portion 112, second portion 114, and third portion 116) that may each provide different outputs (such as color or colors) and/or be perceived differently by a human observer when illuminated. In some implementations, the display cover 111 includes or constitutes a taillight cover of the vehicle 100, or alternatively, the display cover 111 is positioned on or over a taillight of the vehicle 100.

Similarly, as illustrated in the expanded area 125 for passenger side mirror 105 of the vehicle 100, the safety lighting system 120 may include a display cover 121 that includes three different portions (e.g., first portion 122, second portion 124, and third portion 126) that may each provide different outputs (such as color or colors) and/or be perceived differently by a human observer when illuminated. In some implementations, the display cover 121 is positioned on or constitutes an outside surface 106 of at least one of a driver side mirror or a passenger side mirror of the vehicle (e.g., side mirror 105). In some implementations, a display cover is positioned on or constitutes an outside surface of both the driver side mirror and a passenger side mirror of the vehicle.

In some implementations, the first portions 112, 122 may include and/or be positioned over or outside a first light source that is configured for illumination in response to a control system detecting, or receiving information relating to, acceleration of the vehicle 100. For example, the first portions 112, 122 include or constitute a green tinted translucent material that is illuminated when the vehicle 100 is accelerated (e.g., a user/driver presses on a gas pedal). The second portions 114, 124 may include and/or be positioned over or outside a second light source that is configured for illumination in response to the control system for detecting, or receiving information relating to, a deceleration of the vehicle without detecting a braking action of the vehicle. For example, the second portions 114, 124 include or constitute a yellow/amber tinted translucent material that is illuminated when the vehicle 100 is decelerated (e.g., a user/driver steps off of the gas pedal and the car decelerates, but the user does not step on the brake pedal). The third portions 116, 126 may include and/or be positioned over or outside a third light source that is configured for illumination in response to the control system for detecting, or receiving information relating to, a braking action of the vehicle. For example, the third portions 116, 126 include or constitute a red tinted translucent material that is illuminated when the vehicle 100 includes a braking action (e.g., user steps on the brakes).

The light source of each portion of each safety lighting system 110 (e.g., first portion 112, second portion 114, and third portion 116) and safety lighting system 120 (e.g., first portion 122, second portion 124, and third portion 126) may include light emitting diodes (LEDS), incandescent lights, halogen lights, metal halide lights, and the like. The light source of each portion of each safety lighting system 110, 120 may be a colored light source associated with each described constraint (e.g., green for the first portion for acceleration, yellow/amber for the second portion for slowing down, and red for the third portion for braking) that illuminates through a clear/transparent or translucent material, such as a display cover or housing 111 that covers or is positioned over each light source (e.g. as an aftermarket item) of the safety lighting system 110, such that each colored light emits light that is visible through the display cover or housing (e.g., a green LED would illuminate the first portions 112, 122 as green). Alternatively, each light source of each portion of each safety lighting system 110, 120, 150, 160 may be a clear or white light source, and each respective display cover or housing 111 may include a colored translucent material associated with each described constraint (e.g., green colored transparent or translucent material for the first portions 112, 122 for acceleration, yellow/amber colored translucent material for the second portions 114, 124 for slowing down, and red colored translucent material for the third portions 116, 126 for braking), such that each light for each portion of each safety lighting system 110, 120, 150, 160 when illuminated would project a bright white/clear light, but when displayed through each respective colored housing 111 and perceived by a human, colored light would be visible through the housing 111 (e.g., a clear/white light source would appear as green light to another driver).

In an exemplary embodiment, the first portions 112, 122, the second portions 114, 124, and the third portions 116, 126, or each safety light system 110, 120, respectively, are each illuminated by a separate light source for each portion. Alternatively, in some implementations, the first portions 112, 122, the second portions 114, 124, and the third portions 116, 126, or each safety light system 110, 120, respectively, may be illuminated by a single light source. For example, a single light source may be used for the three different portions but may be controlled to illuminate the different portions of each lighting system.

In an exemplary embodiment, the first portions 112, 122, the second portions 114, 124, and the third portions 116, 126, or each safety light system 110, 120, respectively, are separate and discrete areas, that are non-overlapping between each other when viewed from outside the housing 111 or when viewing the rear of the vehicle 100. Alternatively, in some implementations, the first portions 112, 122, the second portions 114, 124, and the third portions 116, 126, or each safety light system 110, 120, respectively, may share an adjacent border or include at least some overlapping regions. In some implementations, each portion is located relatively close to another in a relatively compact area (e.g., within one square foot area). In some implementations, each portion are located further away and less compact (e.g., within a three square foot area).

FIG. 1B illustrates a view of a safety lighting system 150 for use in conjunction with, and/or mounted on, a vehicle 100 in accordance with aspects of the present invention. In particular, FIG. 1B illustrates a safety lighting system 150A, B (also referred to herein as safety lighting system 150) mounted on the rear of the vehicle 100 (e.g., positioned on and/or constituting a right and left taillight area), and a second safety lighting system 160 located on one of the side view mirrors of the vehicle 100 (e.g., a passenger side view mirror in the illustrated embodiment, but could be located on both the driver side mirror and the passenger side mirror). As illustrated in the expanded area 155 for the driver side of the vehicle 100, the safety lighting system 150 may include a plurality of distinct lights that are grouped together in columns. For example, a first type of light 151 may be the same type of light (e.g., color) as the first portion 112 of the safety lighting system 110, a second type of light 152 may be the same type of light (e.g., color) as the second portion 114 of the safety lighting system 110, and a third type of light 153 may be the same type of light (e.g., color) as the third portion 116 of the safety lighting system 110. However, the first type of light 151, second type of light 152, and third type of light 153 may be configured to be displayed in particular configurations. For example, as illustrated in FIG. 1B, each type of light 151, 152, 153, are illustrated in distinct and separate columns and the columns repeat after each other. However, in some implementations, each type of light 151, 152, 153 may be in layouts based on any different configurations (e.g., circular, rows, square, mixed, etc.).

The safety lighting system 150 may also include a display cover (e.g., display cover 111 of FIG. 1A). In some implementations, the display cover may include or constitute a taillight cover of the vehicle 100, or alternatively, the display cover may be positioned on or over a taillight of the vehicle 100.

Similarly, as illustrated in the expanded area 165 for passenger side mirror 105 of the vehicle 100, the safety lighting system 160 may also include a plurality of distinct lights that are grouped together in columns. For example, a first type of light 161 may be the same type of light (e.g., color) as the first portion 122 of the safety lighting system 120, a second type of light 162 may be the same type of light (e.g., color) as the second portion 124 of the safety lighting system 120, and a third type of light 163 may be the same type of light (e.g., color) as the first portion 126 of the safety lighting system 120. However, the first type of light 161, second type of light 162, and third type of light 163 may be configured to be displayed in particular configurations. For example, as illustrated in FIG. 1B, each type of light 161, 162, 163, are illustrated in distinct and separate columns and the columns repeat after each other. Each type of light 161, 162, 163 may be in layouts based on any different configurations (e.g., circular, rows, square, mixed, etc.).

The safety lighting system 160 may also include a display cover (e.g., display cover 121 of FIG. 1A). In some implementations, the display cover may be positioned on or constitutes an outside surface 106 of at least one of a driver side mirror or a passenger side mirror of the vehicle (e.g., side mirror 105). In some implementations, the display cover may be positioned on or constitutes an outside surface 106 of both the driver side mirror and the passenger side mirror of the vehicle.

In some implementations, the first type of lights 151, 161 may include and/or be positioned over or outside a first light source that is configured for illumination in response to a control system detecting, or receiving information relating to, acceleration of the vehicle 100. For example, the first type of lights 151, 161 include or constitute a green tinted translucent material that is illuminated when the vehicle 100 is accelerated (e.g., a user/driver presses on a gas pedal). The second type of lights 152, 162 may include and/or be positioned over or outside a second light source that is configured for illumination in response to the control system for detecting, or receiving information relating to, a deceleration of the vehicle without detecting a braking action of the vehicle. For example, the second type of lights 152, 162 include or constitute a yellow/amber tinted translucent material that is illuminated when the vehicle 100 is decelerated (e.g., a user/driver steps off of the gas pedal and the car decelerates, but the user does not step on the brake pedal). The third type of lights 153, 163 may include and/or be positioned over or outside a third light source that is configured for illumination in response to the control system for detecting, or receiving information relating to, a braking action of the vehicle. For example, the third type of lights 153, 163 include or constitute a red tinted translucent material that is illuminated when the vehicle 100 includes a braking action (e.g., user steps on the brakes).

The light source of each type of light for the safety lighting system 150 (e.g., first type of light 151, second type of light 152, and third type of light 153) and safety lighting system 160 (e.g., first type of light 161, second type of light 162, and third type of light 163) may include light emitting diodes (LEDS), incandescent lights, halogen lights, metal halide lights, and the like. The light source of each type of light of each safety lighting system 150, 160 may be a colored light source associated with each described constraint (e.g., green for the first portion for acceleration, yellow/amber for the second portion for slowing down, and red for the third portion for braking) that illuminates through a clear/transparent or translucent material, such as a display cover or housing that covers or is positioned over each light source (e.g. as an aftermarket item) of the safety lighting system 150, such that each colored light emits light that is visible through the display cover or housing (e.g., a green LED would illuminate the first type of lights 151, 161 as green). Alternatively, each light source of each type of light of each safety lighting system 150, 160 may be a clear or white light source, and each respective display cover or housing may include a colored translucent material associated with each described constraint (e.g., green colored transparent or translucent material for the first type of lights 151, 161 for acceleration, yellow/amber colored translucent material for the second type of lights 152, 162 for slowing down, and red colored translucent material for the third type of lights 153, 163 for braking), such that each light for each type of light of each safety lighting system 150, 160, when illuminated, would project a bright white/clear light, but when displayed through each respective colored housing and perceived by a human, colored light would be visible through the housing (e.g., a clear/white light source would appear as green light to another driver).

In an exemplary embodiment, the first type of lights 151, 161, the second type of lights 152, 162, and the third type of lights 153, 163, or each safety light system 150, 160, respectively, are each illuminated by a separate light source for each portion. Alternatively, in some implementations, the first type of lights 151, 161, the second type of lights 152, 162, and the third type of lights 153, 163, or each safety light system 150, 160, respectively, may be illuminated by a single light source. For example, a single light source may be used for the three different portions may be used, but may be controlled to illuminate the different portions of each lighting system.

In an exemplary embodiment, the first type of lights 151, 161, the second type of lights 152, 162, and the third type of lights 153, 163, or each safety light system 150, 160, respectively, are separate and discrete areas, that are non-overlapping between each other when viewed from outside a housing or when viewing the rear of the vehicle 100. Alternatively, in some implementations, the first type of lights 151, 161, the second type of lights 152, 162, and the third type of lights 153, 163, of each safety light system 150, 160, respectively, may share an adjacent border or include at least some overlapping regions. In some implementations, each portion is located relatively close to another in a relatively compact area (e.g., within one square foot area). In some implementations, each portion are located further away and less compact (e.g., within a three square foot area).

Referring to FIGS. 1A and 1B, in some implementations, each safety lighting system 110, 120, 150, and/or 160 may include a main controller, or a separate controller for each lighting system. The controller, which will be further discussed herein, may be configured to receive speed and/or acceleration/deceleration information relating to the vehicle 100 and to operate/activate/illuminate each light source and/or each portion of the safety lighting system based on the received information. For example, the controller may receive speed information from one or more vehicle speed sensors (VSS), gas pedal/accelerator activation/position information, brake pedal information, position, or brake system activation status, and the like. In some implementations, the controller is included as a part of the safety lighting system 110, 120, 150, 160 (e.g., a microcomputer, a microcontroller, etc.) that receives signals (e.g., directly and/or wirelessly) from the vehicle's 100 computer system and/or from other portions of the vehicle 100 (e.g., signals sent to or associated with the speedometer, tachometer, gas pedal/accelerometer, brake pedal/brake system, etc.). Alternatively, in some implementations, the controller may be embedded as an instruction set or module implemented within a vehicle control system of vehicle 100 (e.g., the vehicle's on-board electrical/computer system).

In some implementations, the safety lighting system 110, 120, 150, 160 includes a power source (e.g., a rechargeable battery) that may be powered (e.g., charged or recharged) by the vehicle's 100 power source (e.g., the alternator or other applicable power source). Alternatively, in some embodiments, the power source may be charged by one or more solar panels (further discussed herein). Alternatively, in some embodiments, the safety lighting system 110, 120, 150, 160 does not include a power source, and thus receives power for the controller and to illuminate the light sources for each portion from the vehicle's 100 electrical system directly (e.g., hard wired, i.e., similar to replacing a taillight component).

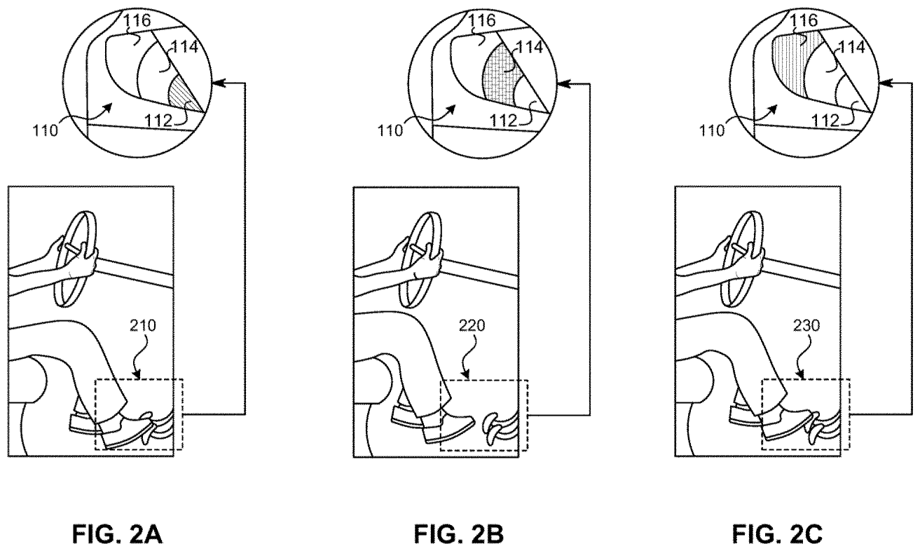

FIGS. 2A-2C illustrate views of using the safety lighting system 110 of FIG. 1A for the vehicle 100 in accordance with aspects of the present invention. In particular, FIG. 2A illustrates a user/driver pushing on the gas pedal with his or her foot as illustrated in area 210. As the user pushes on the gas pedal (e.g., the vehicle accelerates), the first portion 112 of the safety lighting system 110 is illuminated (e.g., indicating an acceleration or increase of speed and illuminating a green light). FIG. 2B illustrates a user/driver releasing his or her foot from the gas pedal as illustrated in area 220. As the user releases his or her foot from the gas pedal (e.g., the vehicle 100 decelerates) and if the user is not operating the brake pedal, the first portion 112 of the safety lighting system 110 is, in one case, no longer illuminated and the second portion 114 of the safety lighting system 110 is illuminated (e.g., indicating a relatively small deceleration or decrease of speed and illuminating a yellow/amber light). FIG. 2C illustrates a user/driver pushing on a brake pedal with his or her foot as illustrated in area 230. As the user pushes the brake pedal with his or her foot (e.g., a braking action and the vehicle 100 decelerates at relatively faster rate), the second portion 114 of the safety lighting system 110 is, in one case, no longer illuminated and the third portion 116 of the safety lighting system 110 is illuminated (e.g., indicating a deceleration or decrease of speed and/or a braking action, and illuminating a red light).

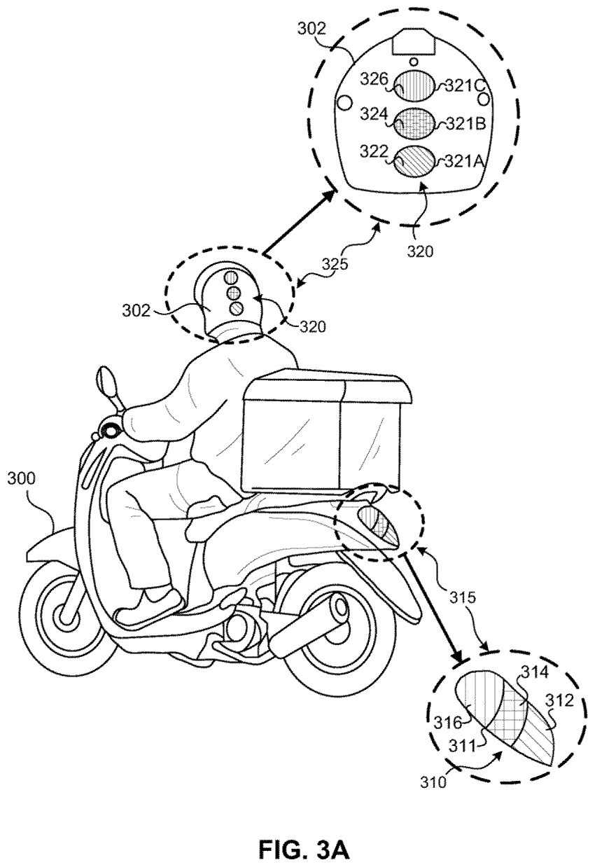

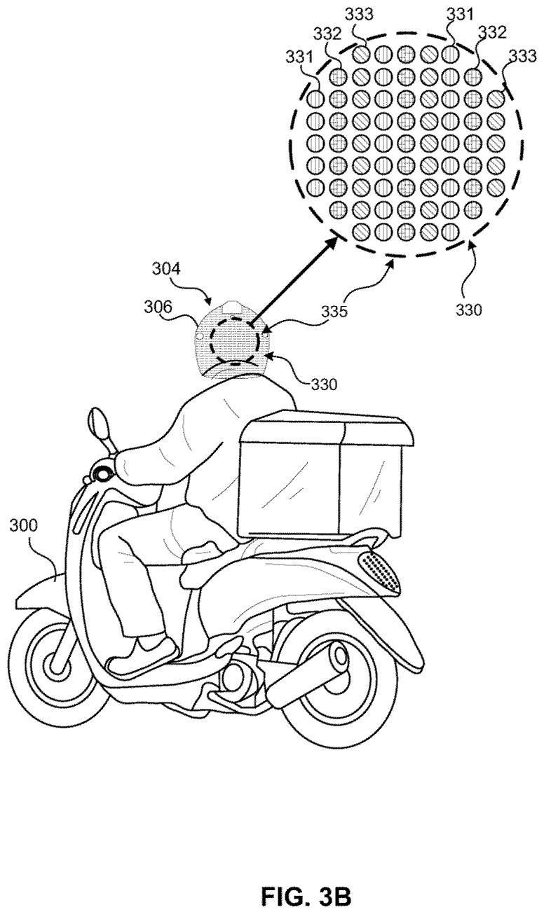

FIG. 3A illustrates a view of a safety lighting system 310 as a taillight for a vehicle 300 (e.g., a scooter or motorcycle) and a safety lighting system 320 for a helmet for a user/motorcyclist of the vehicle 300 in accordance with aspects of the present invention. In particular, FIG. 3A illustrates a safety lighting system 310 located at the rear of the vehicle 300 (e.g., a taillight area), and a second safety lighting system 320 located on a helmet 302 (e.g., placed via an adhesive or sticker or alternatively embedded within the structure of the helmet 302). As illustrated in the expanded area 315 for the taillight of the vehicle 300, the safety lighting system 310 may include a display cover or housing 311 (e.g., a housing or cover) that includes three different portions (e.g., first portion 312, second portion 314, and third portion 316) that may each provide different colors or other effects when illuminated. In some implementations, the display cover or housing 311 includes or takes the form of a taillight of the vehicle 300, or alternatively, the display cover or housing 311 is positioned over an existing taillight of the vehicle 300 as an aftermarket item. Similarly, as illustrated in the expanded area 325 for the helmet 302, the safety lighting system 320 may include a display cover 321 that includes three different portions (e.g., first portion 322, second portion 324, and third portion 326) that may each provide different colors or other effects when illuminated. For example, as illustrated, a display cover 321A covers the first portion 322, a display cover 321B covers the second portion 324, and a display cover 321C covers the third portion 326. For example, each display cover (e.g., display covers 321A, 321B, 321C) may be a transparent or translucent housing or cover that covers each portion. Alternatively, a single display cover 321 may be used as a cover or housing, similar to the taillight example as illustrated by display cover 310 (e.g., a single transparent or translucent housing or cover that covers each portion).

In some implementations, the first portions 312, 322 may include and/or be positioned over or outside a first light source that is configured for illumination in response to the control system detecting, or receiving information relating to, acceleration of the vehicle 300. For example, the first portions 312, 322 include or constitute a green tinted translucent material that is illuminated when the vehicle 300 is accelerated (e.g., a user/motorcyclist increases the throttle/accelerator). The second portions 314, 324 may include and/or be positioned over or outside a second light source that is configured for illumination in response to the control system for detecting, or receiving information relating to, a deceleration of the vehicle without detecting a braking action of the vehicle. For example, the second portions 314, 324 include or constitute a yellow/amber tinted translucent material that is illuminated when the vehicle 300 is decelerated (e.g., a user/motorcyclist decreases the throttle/accelerator and the motorcycle decelerates, but the motorcyclist does not grasp or push a brake lever). The third portions 316, 326 may include and/or be positioned over or outside a third light source that is configured for illumination in response to the control system for detecting, or receiving information relating to, a braking action of the vehicle. For example, the third portions 316, 326 include or constitute a red tinted translucent material that is illuminated when the vehicle 300 includes a braking action (e.g., motorcyclist grasp's the hand brake level or pushes a foot brake lever).

The light source of each portion of each safety lighting system 310 (e.g., first portion 312, second portion 314, and third portion 316) and safety lighting system 320 (e.g., first portion 322, second portion 324, and third portion 326) may include light emitting diodes (LEDS), incandescent lights, halogen lights, metal halide lights, and the like. The light source of each portion of each safety lighting system 310, 320 may be a colored light source associated with each described constraint (e.g., green for the first portion for acceleration, yellow/amber for the second portion for slowing down, and red for the third portion for braking) that illuminates through a clear/transparent or translucent material, such as a display cover or housing 311 that covers or is positioned over each light source (e.g. as an aftermarket item) of the safety lighting system 310, such that each colored light emits light that is visible through the display cover or housing 311 (e.g., a green LED would illuminate the first portions 312, 322 as green). Alternatively, each light source of each portion of each safety lighting system 310, 320 may be a clear or white light source, and each respective portion may include a colored translucent material associated with each described constraint (e.g., green colored transparent or translucent material for the first portions 312, 322 for acceleration, yellow/amber colored translucent material for the second portions 314, 324 for slowing down, and red colored translucent material for the third portions 316, 326 for braking), such that each light for each portion of each safety lighting system 310, 320, when illuminated would project a bright white/clear light, but when displayed through each respective colored housing and perceived by a human, colored light would be visible through the housing 311 (e.g., a clear/white light source would appear as green light to another driver).

FIG. 3B illustrates a view of a safety lighting system 330 for a helmet for a user/motorcyclist of the vehicle 300 in accordance with aspects of the present invention. In particular, FIG. 3B illustrates a safety lighting system 330 located on a helmet 304 (e.g., placed via an adhesive or sticker or alternatively embedded within the structure of the helmet 304). In some implementations, the helmet 304 includes an outer layer 306 or housing that covers the helmet. In some implementations, the outer layer 306 of the helmet 304 includes a translucent layer that is made of a strong, lightweight, heat-resistant, and/or synthetic fiber.

As illustrated in the expanded area 335 for the helmet 304, the safety lighting system 330 may include a plurality of distinct lights that are grouped together in columns. For example, a first type of light 331 may be the same type of light (e.g., color) as the first portion 322 of the safety lighting system 320, a second type of light 332 may be the same type of light (e.g., color) as the second portion 324 of the safety lighting system 320, and a third type of light 333 may be the same type of light (e.g., color) as the third portion 326 of the safety lighting system 320. However, the first type of light 331, second type of light 332, and third type of light 333 may be configured to be displayed in particular configurations. For example, as illustrated in FIG. 3B, each type of light 331, 332, 333, are illustrated in distinct and separate columns and the columns repeat after each other. However, in some implementations, each type of light 331, 332, 333 may be in layouts based on any different configurations (e.g., circular, rows, square, mixed, etc.).

The safety lighting system 330 may also include a display cover (e.g., display cover 321 of FIG. 3B) The display cover (e.g., display covers 321A, 321B, 321C) may be a transparent or translucent housing or cover that covers each portion. Alternatively, a single display cover 321 may be used as a cover or housing, similar to the taillight example as illustrated by display cover 310 (e.g., a single transparent or translucent housing or cover that covers each portion).

In some implementations, the first type of lights 331 may include and/or be positioned over or outside a first light source that is configured for illumination in response to the control system detecting, or receiving information relating to, acceleration of the vehicle 300. For example, the first type of lights 331 include or constitute a green tinted translucent material that is illuminated when the vehicle 300 is accelerated (e.g., a user/motorcyclist increases the throttle/accelerator). The second type of lights 332 may include and/or be positioned over or outside a second light source that is configured for illumination in response to the control system for detecting, or receiving information relating to, a deceleration of the vehicle without detecting a braking action of the vehicle. For example, the second type of lights 332 include or constitute a yellow/amber tinted translucent material that is illuminated when the vehicle 300 is decelerated (e.g., a user/motorcyclist decreases the throttle/accelerator and the motorcycle decelerates, but the motorcyclist does not grasp or push a brake lever). The third type of lights 333 may include and/or be positioned over or outside a third light source that is configured for illumination in response to the control system for detecting, or receiving information relating to, a braking action of the vehicle. For example, the third type of lights 333 include or constitute a red tinted translucent material that is illuminated when the vehicle 300 includes a braking action (e.g., motorcyclist grasp's the hand brake level or pushes a foot brake lever).

The light source of each type of light of the safety lighting system 330 (e.g., first type of light 331, second type of light 332, and third type of light 333) may include light emitting diodes (LEDS), incandescent lights, halogen lights, metal halide lights, and the like. The light source of each portion of the safety lighting system 330 may be a colored light source associated with each described constraint (e.g., green for the first portion for acceleration, yellow/amber for the second portion for slowing down, and red for the third portion for braking) that illuminates through a clear/transparent or translucent material, such as a display cover or a housing that covers or is positioned over each light source (e.g. as an aftermarket item) of the safety lighting system 330 such that each colored light emits light that is visible through a display cover or a housing (e.g., a green LED would illuminate the first type of light 331 as green). Alternatively, each light source of the safety lighting system 330 (e.g., first type of light 331, second type of light 332, and third type of light 333) may be a clear or white light source, and each respective portion may include a colored translucent material associated with each described constraint (e.g., green colored transparent or translucent material for the first type of light 331 for acceleration, yellow/amber colored translucent material for the second type of light 332 for slowing down, and red colored translucent material for the third type of light 333 for braking), such that each type of light for the safety lighting system 330, when illuminated would project a bright white/clear light, but when displayed through each respective colored housing and perceived by a human, colored light would be visible through a housing, such as housing 311 of FIG. 3A (e.g., a clear/white light source would appear as green light to another driver).

Referring to FIGS. 3A and 3B, in some implementations, each safety lighting system 310, 320, 330 may include a main controller, or a separate controller for each lighting system. The controller, which will be further discussed herein, may be configured to receive speed and/or acceleration/deceleration information relating to the vehicle 300 and to operate/activate/illuminate each light source and/or each portion of the safety lighting system based on the received information. For example, the controller may receive speed information from one or more vehicle speed sensors (VSS), gas pedal/accelerator activation/position information, brake pedal information, position, or brake system activation status, and the like. In some implementations, the controller is included as a part of the safety lighting system 310, 320, 330 (e.g., a microcomputer, a microcontroller, etc.) that receives signals (e.g., directly and/or wirelessly) from the vehicle's 300 computer system and/or from other portions of the vehicle 300 (e.g., signals sent to or associated with the speedometer, tachometer, gas pedal/accelerometer, brake pedal/brake system, etc.). Alternatively, in some implementations, the controller may be embedded as an instruction set or module implemented within a vehicle control system of vehicle 300 (e.g., the vehicle's on-board electrical/computer system).

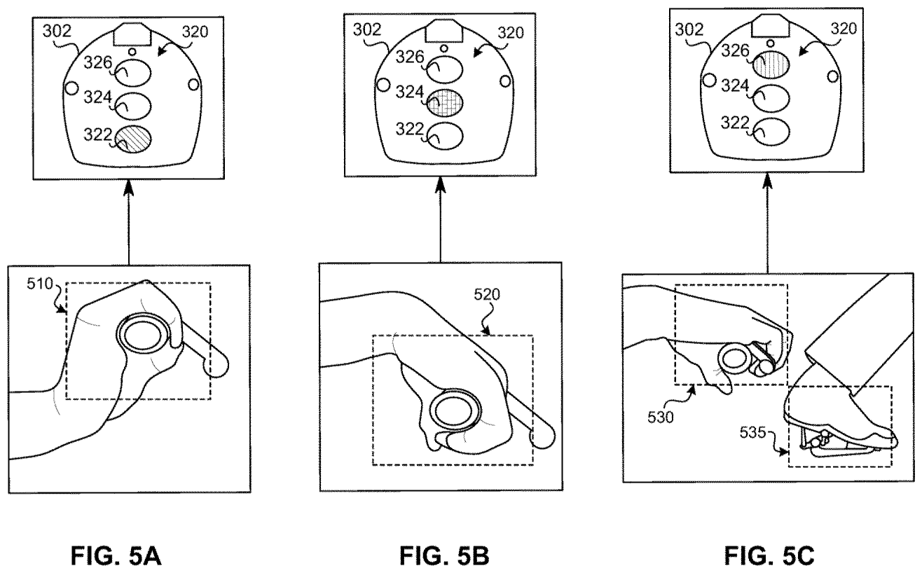

In some implementations, the safety lighting system 310, 320, 330, may include a power source (e.g., a rechargeable battery) that may be powered (e.g., charged or recharged) by the vehicle's 300 power source (e.g., the alternator or other applicable power source). Alternatively, in some embodiments, the power source may be charged by one or more solar panels (further discussed herein with reference to FIG. 5). Alternatively, in some embodiments, the safety lighting system 310, 320, 330 does not include a power source, and thus receives power for the controller and to illuminate the light sources for each portion from the vehicle's 300 electrical system directly (e.g., hard wired, i.e., similar to replacing a taillight component).

In some implementations, each portion 312, 314, 316 of the safety lighting system 320, and each type of lights 331, 332, 333 of the safety lighting system 330 may be located anywhere on the helmet 302, 304, respectively, as long as each portion 312, 314, 316 of the safety lighting system 320 and each type of lights 331, 332, 333 of the safety lighting system 330 are visible (or at least a portion thereof) by a surrounding or adjacent driver or pedestrians during use. Additionally, or alternatively, in some implementations, the safety lighting systems 320, 330 can take the form of or include adhesive objects such as stickers on an inner surface thereof and so that the safety lighting systems 320, 330 may be placed on a helmet, including the helmet of the driver and/or of a passenger (e.g., a person sitting behind the operator of the vehicle 300). Additionally, or alternatively, in some implementations, the safety lighting systems 320, 330 can be adhered or otherwise secured to any other portion of the motorcyclist such as a back, backpack, legs, or other locations of the vehicle, and may be replicated to have multiple safety lighting systems 320, 330 at different locations (e.g., adding the illumination to multiple portions of the vehicle, similar to adding reflectors to a bicycle).

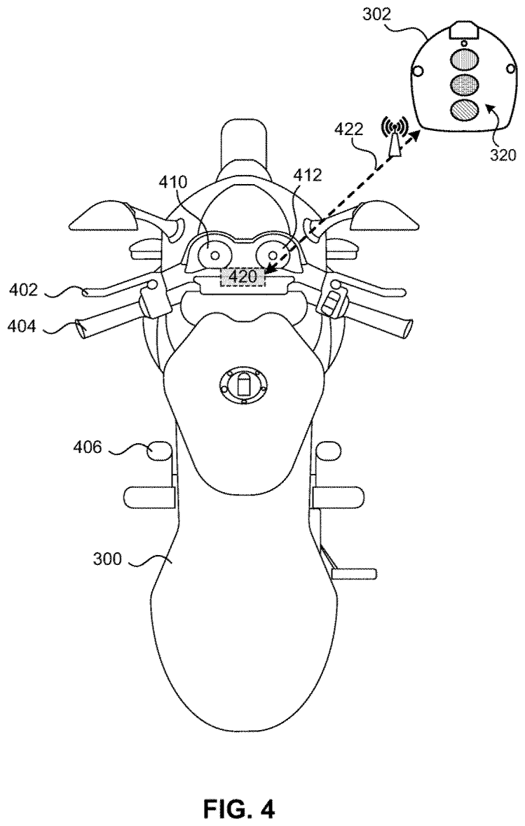

FIG. 4 illustrates a perspective view of the vehicle 300 (e.g., a scooter or motorcycle) of FIG. 3A in accordance with aspects of the present invention. In particular, FIG. 4 illustrates the safety lighting system 320 on the helmet 302 and operatively connected via a controller to a transceiver 420 via a wireless electrical connection 422 that is located on top of or coupled to a portion of the vehicle 300 of FIG. 3A in accordance with aspects of the present invention. As illustrated in FIG. 4, the vehicle 300 includes a hand lever brake 402, a throttle/accelerator 404, a foot brake lever 406, a speedometer 410, and a tachometer 412, all of which may produce one or more electrical signals that may be sent to the controller of the vehicle 300 and/or the controller of safety lighting system 320 at the helmet 302 via the transceiver 420 and the wireless electrical connection 422. For example, speed information, acceleration/deceleration information and other data such as braking information may be sent as data signals by these various components of the vehicle 300 via the transceiver 420 and the wireless electrical connection 422 the controller of the safety lighting system 320 at the helmet 302 to control the illumination of each of the light sources for each portion 322, 324, and 326, per one or more illumination protocols, as discussed herein.

The wireless electrical connection 422 may connect a controller of the safety lighting system 320 to a transceiver 420 at the vehicle 300 and may communicate wirelessly through a communication interface, which may include digital signal processing circuitry where necessary. A communication interface may provide for communications under various modes or protocols, such as GSM voice calls, SMS, EMS, or MMS messaging, CDMA, TDMA, PDC, WCDMA, CDMA2000, or GPRS, among others. Such communication may occur, for example, through a transceiver (e.g., a radio-frequency transceiver). In addition, short-range communication may occur, such as using a Bluetooth®, WiFi, or other such transceiver (not shown). In addition, the transceiver 420 may provide additional wireless data to the safety lighting system 320, which may be used as appropriate by applications running on the controller of the safety lighting system 320 or part of the computing system of the vehicle 300.

FIGS. 5A-5C illustrate views of using the safety lighting system 320 for the helmet 302 of FIG. 3A in accordance with aspects of the present invention. In particular, FIG. 5A illustrates a user/motorcyclist turning the throttle/accelerator (e.g., throttle/accelerator 404) with his or her hand as illustrated in area 510. As the user turns the throttle/accelerator (e.g., the vehicle 300 accelerates), the first portion 322 of the safety lighting system 320 is illuminated (e.g., upon detecting an acceleration or increase of speed and illuminating a green light). FIG. 5B illustrates a user/motorcyclist releasing his or her hand from the throttle/accelerator as illustrated in area 520. As the user releases his or her hand from the throttle/accelerator (e.g., the vehicle decelerates) and if the user/motorcyclist has not pushed the foot brake pedal or pulled the hand brake lever, the first portion 322 of the safety lighting system 320 is unilluminated and the second portion 324 of the safety lighting system 320 is illuminated (e.g., detecting a deceleration or decrease of speed and illuminating a yellow/amber light). FIG. 5C illustrates a user/motorcyclist grasping a hand brake lever (e.g., hand brake lever 402) with his or her hand as illustrated in area 530 and/or pushing on a foot brake pedal/lever (e.g., foot brake lever 406) with his or her foot as illustrated in area 535. As the user/motorcyclist initiates braking by either pushing on a foot brake pedal/lever or grasping a hand brake lever (e.g., initiates a braking action where the vehicle decelerates at a faster rate than only releasing the throttle/accelerator), the second portion 324 of the safety lighting system 320 is unilluminated and the third portion 326 of the safety lighting system 320 is illuminated (e.g., detecting a deceleration or decrease of speed and illuminating a red light).

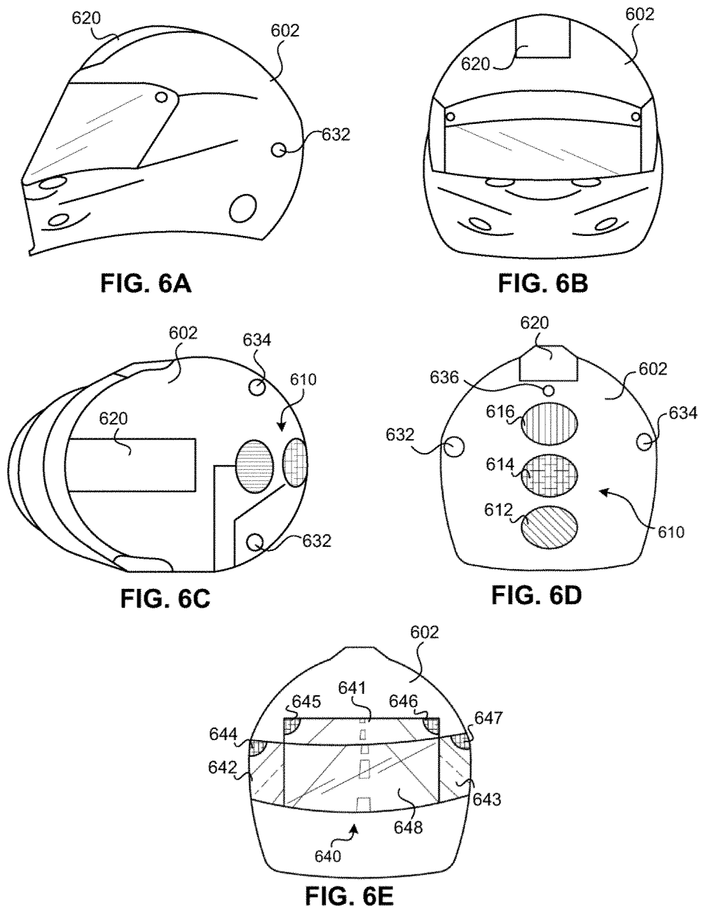

FIGS. 6A-6E illustrate views of using a safety lighting system for a helmet 602 in accordance with aspects of the present invention. In particular, FIG. 6A illustrates a side view of the helmet 602 that includes a solar panel 620 (e.g., for charging a power source for a safety lighting system) and a motion detection camera 632. FIG. 6B illustrates a front view of the helmet 602 that includes solar panel 620. FIG. 6C illustrates a top view of the helmet 602 that includes solar panel 620, motion detection cameras 632, 634, a view of a portion of the safety lighting system 610 (e.g., top two light sources). FIG. 6D illustrates a back view of the helmet 602 that includes solar panel 620, motion detection cameras 632, 634, 636, and the safety lighting system 610, including the first portion 612, the second portion 614, and the third portion 616 (e.g., first portion 322, second portion 324, and third portion 326, respectively, of the safety lighting system 320 of FIGS. 3-5).

FIG. 6E illustrates an inside view of the helmet 602 from a motorcyclists' perspective. In particular, FIG. 6E illustrates the inside of the helmet 602 that includes display screens 640 (e.g., left side screen 642, right side screen 643, rear view screen 641, and front view screen 648), and inner caution lights 644, 645, 646, 647. The inner caution lights 644, 645, 646, 647 are the alerting lights inside the helmet 602 that may illuminate based on object detection of nearby objects (e.g., vehicles) traveling in close proximity to the motorcyclist and detected by a sensor within or connected to the helmet 602. For example, one or more of the inner caution lights 644, 645, 646, 647 may be activated or alerted because of an approaching vehicle. The inner caution lights 644, 645, 646, 647 may consist of one color, such as yellow which is standard for a caution light. Additionally, the helmet 602 may include two side cameras (e.g., a left side camera and a right side camera) that are alerted on and connected to the yellow caution lights when the throttle is released, revealing potential blind spots on both the left side and the right side, respectively (e.g., left side screen 642, right side screen 643). When the throttle is engaged, a rear view camera (e.g., rear view screen 641) may be alerted on and connected to a green light so that the rider/motorcyclist may be aware of a rear view for upcoming vehicles behind the vehicle. In some implementations, when the brakes are engaged and throttle disengaged, both the rear view camera (e.g., rear view screen 641) and side view cameras (e.g., left side screen 642, right side screen 643) may be alerted on and connected to the red light (e.g., third portion 616), giving the motorcyclist full rear and peripheral view (e.g., rear view screen 641).

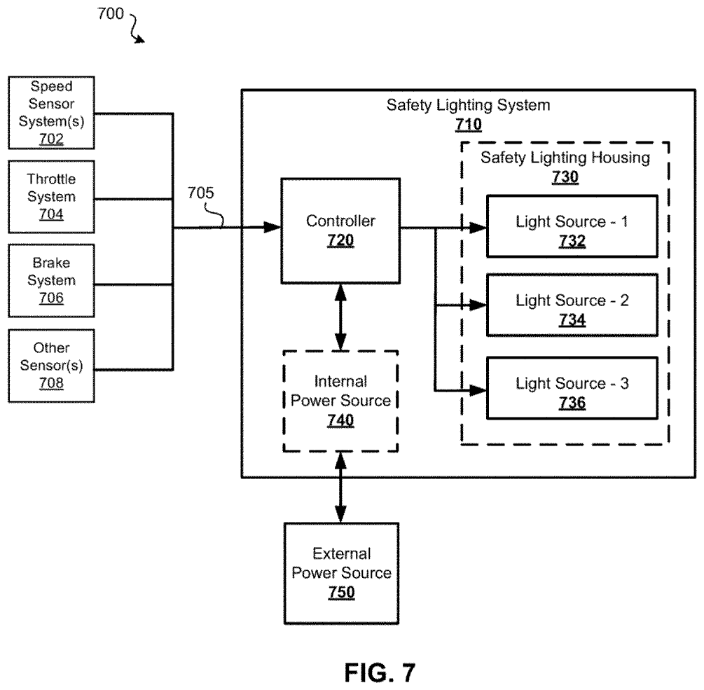

FIG. 7 illustrates an example block diagram 700 of the inputs and outputs of a controller 720 of an example safety lighting system 710 in accordance with aspects of the present invention. In an exemplary embodiment, the safety lighting system 710 includes a controller 720, access to power from an internal or external power source, and three light sources (e.g., light source-1 732, light source-2 734, and light source-3 736). In some implementations, each light source is contained as one unit within a safety lighting housing 730 (e.g., a taillight fixture as illustrated in FIGS. 1 and 2). Alternatively, each light source may be stand alone apparatus (e.g., three separate lights affixed to the back of a helmet as illustrated in FIGS. 3-5, or affixed to a tail light).

The controller 720 of the safety lighting system (e.g., safety lighting systems/devices 110, 120, 320, etc.), receives speed information 705 from one or more data sources. For example, the controller 720 may be configured to receive speed information from one or more vehicle speed sensors (VSS) (e.g., speed sensor system(s) 702), throttle information (e.g., acceleration data) from the throttle system 704, braking information (e.g., deceleration or braking action data) from the brake system 706, and other information from other sensor(s) 708. Other information may include information from smart computers for the vehicle, or other sources of speed information from the vehicle or from other devices (e.g., GPS speed information via a mobile device). The controller 720 then determines, based on the received information 705 (e.g., speed, velocity, deceleration, braking actions, etc.), the activation or deactivation of each of the light sources (e.g., light source-1 732, light source-2 734, and light source-3 736). For example, the first light source-1 732 (e.g., a green light) may be programmed for illumination in response to sufficient acceleration of the associated vehicle, where in one case pressure is applied to the gas pedal which also accelerates the vehicle. The illumination of the first light source-1 732 (e.g., a green light) may continue as long as pressure is applied to the gas pedal and/or acceleration continues. Once pressure is released from the gas pedal, moderate deceleration occurs of the associated vehicle, which can be detected/displayed by the speedometer, which deceleration may cause activation of the second light source-2 734 (e.g., a yellow/amber light). Once braking is applied and the vehicle experience greater deceleration, activation/illumination of the second light source-2 734 (e.g., a yellow/amber light) may cease and the activation/illumination of the third (red) portion may occur (e.g., red LEDs or a light source that illuminates a red material) until the brakes are released and/or the greater deceleration ceases, after which activation/illumination of the third light source-3 736 (e.g., a red light) may cease and the second light source-2 734 (e.g., a yellow/amber light) is activated/illuminated for the second light source-2 734 (e.g., a yellow/amber light). Accordingly, once acceleration commences which activates the first light source-1 732 (e.g., a green light) the light source of the first light source-1 732 (e.g., a green light) can be illuminated throughout the continual activation of the accelerator (e.g., during acceleration or maintaining a constant speed). This illustrates the sequential illumination of the three portions of illumination, specifically the first light source-1 732 (e.g., a green light), the second light source-2 734 (e.g., a yellow/amber light), and the third light source-3 736 (e.g., a red light).

In some implementations, the safety lighting system 710 includes an internal power source 740 (e.g., a battery). Additionally, or alternatively, in some implementations, the safety lighting system 710 includes an external power source 750 (e.g., operatively coupled with the vehicle's electrical system or other power source such as solar powered). Additionally, or alternatively, in some implementations, the safety lighting system 710 includes a combination of both the internal power source 740 and the external power source 750 (e.g., a rechargeable battery).

In an exemplary implementation, a safety lighting system described herein (e.g., safety lighting systems/devices 110, 120, 320, 710, etc.), includes a first portion (e.g., a green tinted portion associated with accelerating) that is configured for illumination in response to detecting acceleration of the vehicle, a second portion (e.g., a yellow/amber tinted portion associated with slowing down without braking) that is configured for illumination in response to detecting a slight or moderate deceleration of the vehicle, in one case without detecting a braking action of the vehicle (e.g., a user steps off of the gas pedal and the car decelerates, but the user does not step on the brake pedal), and a third portion (e.g., a red tinted portion associated with braking) that includes a third light source and is configured for illumination in response to greater deceleration and/or detecting a braking action of the vehicle (e.g., user steps on the brakes). Additionally, in the exemplary implementation, the safety lighting systems described herein include a controller (e.g., controller 720) operatively connected to a power source, the first portion, the second portion, and the third portion. In some implementations, the controller may be configured to receive speed, acceleration, throttle and braking information of a vehicle and to operate each light source of each portion of the safety lighting system based on the received information. For example, the controller may receive speed information from one or more vehicle speed sensors (VSS), gas pedal information, brake pedal information, and the like.

Alternatively, in some implementations, a safety lighting system described herein (e.g., safety lighting systems/devices 110, 120, 320, 710, etc.), may include a first light source (e.g., a green tinted portion associated with accelerating), a second light source (e.g., a yellow/amber tinted portion associated with slowing down without braking), a third light source (e.g., a red tinted portion associated with braking), and a single display cover that encloses the first light source, the second light source, and the third light source. The safety light system may further include a controller (e.g., controller 720) communicatively coupled to the vehicle and configured to receive at least one of acceleration/deceleration information, braking information, or throttle control information relating to the vehicle. The controller (e.g., controller 720) may be configured/programmed to responsively cause illumination to the first light source upon receiving information associated with at least one of acceleration or operation of the throttle of the vehicle, responsively cause illumination to the second light source upon receiving information associated with at least one of relatively low deceleration of the vehicle or deceleration of the vehicle without braking, and responsively cause illumination second light source upon receiving information associated with at least one of relatively high deceleration or braking of the vehicle.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A safety lighting system for a vehicle, the safety lighting system comprising:
a display cover including a first portion, a second portion, and a third portion;
at least one light source configured to selectively illuminate the first, second, and third portions of the display cover; and
a controller communicatively coupled to the vehicle and configured to receive at least one of acceleration/deceleration information, braking information, or throttle control information relating to the vehicle, and to responsively cause illumination of the first portion upon at least one of acceleration or operation of the throttle of the vehicle, to cause illumination of the second portion upon at least one of relatively low deceleration of the vehicle or deceleration of the vehicle without braking, and to cause illumination of the third portion upon at least one of relatively high deceleration or braking of the vehicle.

2. The safety lighting system of claim 1, wherein the display cover comprises or is positioned over a taillight of the vehicle.

3. The safety lighting system of claim 2, wherein each portion of the safety lighting system is configured to be visible to a driver of another vehicle that is located behind the vehicle.

4. The safety lighting system of claim 1, wherein the display cover is positioned on an outside surface of at least one of a driver side mirror or a passenger side mirror of the vehicle.

5. The safety lighting system of claim 1, wherein the at least one light source includes a first light element configured to selectively illuminate the first portion, a second light element configured to selectively illuminate the second portion, and a third light element configured to selectively illuminate the third portion.

6. The safety lighting system of claim 5, wherein an outer surface of each light element is transparent or translucent.

7. The safety lighting system of claim 6, wherein, when illuminated, the first light element, the second light element, and the third light element are visible through the outer surface of each lighting element.

8. The safety lighting system of claim 5, wherein an inner surface of each light element comprises an adhesive surface.

9. The safety lighting system of claim 5, wherein, when illuminated, the first light element, the second light element, and the third light element are visible through a transparent or translucent outer surface of the housing.

10. The safety lighting system of claim 5, wherein the first light element, the second light element, and the third light element each comprise at least one of:
a light emitting diode (LED);
a plurality of LEDs;
an incandescent light;
a halogen light; or
a metal halide light.

11. The safety lighting system of claim 1, wherein the first portion, the second portion, and the third portion are installed on or within a rear facing surface of a helmet.

12. The safety lighting system of claim 1, wherein the at least one light source is wirelessly connected to the controller.

13. The safety lighting system of claim 1, further comprising a housing, wherein the housing incorporates or encloses at least one of the first portion, the second portion, the third portion, the at least one light source, and the controller.

14. The safety lighting system of claim 1, wherein the controller is operatively connected to a vehicle power source.

15. The safety lighting system of claim 1, wherein the controller is operatively connected to a power source that is separate from a vehicle power source.

16. The safety lighting system of claim 15, wherein the safety lighting system comprises one or more solar panels that are configured to be mounted on top of the vehicle or on top of a helmet, wherein system includes a power source operatively coupled to the controller and configured to be charged by the one or more solar panels.

17. The safety lighting system of claim 1, the controller is configured to illuminate each portion based on a dynamic display configuration, wherein the dynamic display configuration is based on at least one of an illumination pattern, an illumination area, an illumination frequency, an illumination color, and an illumination intensity.

18. The safety lighting system of claim 1, wherein the first portion is configured for illumination in a first color, the second portion is configured for illumination in a second color different from the first color, and the third portion is configured for illumination in a third color different from the first and second colors.

19. A method for using a safety lighting system for a vehicle, wherein the safety lighting system comprises: i) a display cover including a first portion, a second portion, and a third portion, ii) at least one light source configured to selectively illuminate the first, second, and third portions of the display cover, and iii) a controller, the method comprising:
receiving, at the controller, first acceleration/deceleration information and first braking information of the vehicle;
determining, by the controller and based on the first acceleration/deceleration information, that the vehicle is accelerating, and in response, illuminating a first portion;
receiving, at the controller, second acceleration/deceleration information and second braking information of the vehicle;
determining, by the controller and based on the second acceleration/deceleration information and the second braking information, that the vehicle is decelerating without a braking action, and in response, illuminating a second portion;
receiving, at the controller, third acceleration/deceleration information and third braking information of the vehicle; and
determining, by the controller and based on the third acceleration/deceleration information and the third braking information, that the vehicle is decelerating with a braking action, and in response, illuminating a third portion.

20. A safety lighting system for a vehicle, the safety lighting system comprising:
a first light source;
a second light source;
a third light source;
a display cover that encloses the first light source, the second light source, and the third light source; and
a controller communicatively coupled to the vehicle and configured to receive at least one of acceleration/deceleration information, braking information, or throttle control information relating to the vehicle,
wherein the controller is configured to:
responsively cause illumination to the first light source upon receiving information associated with at least one of acceleration or operation of the throttle of the vehicle;
responsively cause illumination to the second light source upon receiving information associated with at least one of relatively low deceleration of the vehicle or deceleration of the vehicle without braking; and
responsively cause illumination second light source upon receiving information associated with at least one of relatively high deceleration or braking of the vehicle.
